(19) United States
(12) Patent Application Publication
(10) Pub. No.: US 2014/0020796 A1
(43) Pub. Date: Jan. 23, 2014

(54) ALUMINUM ALLOY CONDUCTOR

(71) Applicants: FURUKAWA AUTOMOTIVE SYSTEMS INC., Shiga (JP); Furukawa Electric Co., Ltd., Tokyo (JP)

(72) Inventors: Shigeki SEKIYA, Tokyo (JP); Kyota SUSAI, Tokyo (JP)

(73) Assignees: FURUKAWA AUTOMOTIVE SYSTEMS INC., Shiga (JP); Furukawa Electric Co., Ltd., Tokyo (JP)

(21) Appl. No.: 14/037,869

(22) Filed: Sep. 26, 2013

Related U.S. Application Data
(63) Continuation of application No. PCT/JP2012/058335, filed on Mar. 29, 2012.

(30) Foreign Application Priority Data
Mar. 31, 2011 (JP) 2011-080344

(51) Int. Cl. H01B 1/02

(52) U.S. Cl. CPC H01B 1/023
USPC 148/550; 148/439

(57) ABSTRACT

An aluminum alloy conductor, which has a texture in which an area ratio of grains each having a (100) plane and being positioned in parallel to a cross-section vertical to a wire-drawing direction of a wire is 20% or more, and which has a grain size of 1 to 30 μm on the cross-section vertical to the wire-drawing direction of the wire.

### TECHNICAL FIELD

The present invention relates to an aluminum alloy conductor that is used as a conductor of an electrical wiring.

### BACKGROUND ART

Hitherto, a member in which a terminal (connector) made of copper or a copper alloy (for example, brass) is attached to electrical wires composed of conductors of copper or a copper alloy, which is called a wire harness, has been used as an electrical wiring for movable bodies, such as automobiles, trains, and aircrafts. However, in weight reduction of movable bodies in recent years, studies have been progressing on use of aluminum or an aluminum alloy that is lighter than copper or a copper alloy, as a conductor for an electrical wiring.

The specific gravity of aluminum is about one-third of that of copper, and the electrical conductivity of aluminum is about two-thirds of that of copper (when pure copper is considered as a criterion of 100% IACS, pure aluminum has about 66% IACS). Therefore, in order to pass an electrical current through a conductor wire material of pure aluminum, in which the intensity of the electrical current is identical to that through a conductor wire material of pure copper, it is necessary to adjust the cross-sectional area of the conductor wire material of pure aluminum to about 1.5 times larger than that of the conductor wire material of pure copper, but aluminum conductor is still more advantageous than copper conductor in that the former has an about half mass of the latter.

Herein, the term “% IACS” mentioned above represents an electrical conductivity when the resistivity 1.7241×10⁻⁸ Ωm of International Annealed Copper Standard is defined as 100% IACS.

There are some problems in using the aluminum as a conductor of an electrical wiring for movable bodies, one of which is improvement in resistance to bending fatigue. The reason is that a repeated bending stress is applied to a wire harness attached to a door or the like, due to opening and closing of the door. A metal material, such as aluminum, is broken (fatigue breakage) at a certain number of times of repeating of applying a load when the load is applied to or removed repeatedly as in opening and closing of a door, even at a low load at which the material is not broken by one time of applying the load thereto. When the aluminum conductor is used in an opening and closing part, if the conductor is poor in resistance to bending fatigue, it is concerned that the conductor is broken in the use thereof, to result in lack of durability and reliability.

In general, it is considered that as a material is higher in mechanical strength, it is better in fatigue property. Thus, although it is preferable if an aluminum wire high in mechanical strength is utilized, since it is required that a wire harness can be easily handled at the time of installation thereof (an operation of attaching it to a vehicle body), it is preferred that the strength be not excessively high so that excessive force is not required. Due to its complicated circuit configuration, a wire harness is manually assembled such that connectors attached to the wire harness are connected to each other, or that the wire harness is bent to fit into a predetermined circuit. Under such circumstances, if the strength of electrical wires is too high, excessive force is required when the wire harness is bent or lifted up. Therefore, the operation becomes highly troublesome to operators who repeat the operation for several hours a day, and it is expected that operability is deteriorated. Generally, regarding the configuration of a wire harness, an electrical wire is handled, which is produced by bundling several to several ten metal wires into a stranded wire and applying a coating thereon; however, it is known that the strength of the metal wires affects the strength of the electrical wire. Therefore, there is a demand for the development of a low strength metal wire which allows easy handling by operators.

Due to the problems and demand as described above, there is a demand for a conductive wire high in resistance to bending fatigue even at a low strength. Furthermore, flexibility is also required in handleability, and in many occasions, use is made of annealed materials, which can secure an elongation of 10% or more, which is an index for the evaluation of flexibility.

Therefore, it is required for the aluminum conductors that can be used in an electrical wiring for movable bodies, a material which has an appropriate yield strength with good handleability to operators, which has an electrical conductivity needed to allow a large electrical current to flow, and which is excellent in resistance to bending fatigue. Herein, the term yield strength refers to the stress at the time of occurring a defined permanent elongation after the removal of force, and may serve as an index of mechanical strength for indicating operability.

For applications for which such a demand is exist, ones of pure aluminum-based alloys represented by aluminum alloy wires for electrical power lines (JIS A1060 and JIS A1070) cannot sufficiently tolerate a repeated bending stress that is generated by opening and closing of a door or the like. Furthermore, a material obtained by adding various alloying elements to form an aluminum alloy has a problem that the phenomenon of solid solution of the alloying elements added to in aluminum causes lowering in electrical conductivity, and due to too high yield strength, handleability is poor. Accordingly, it is essential to limit and select the alloying elements so that breakage of wire does not occur, and there is a need to prevent lowering in electrical conductivity and to appropriately control yield strength and resistance to bending fatigue.

Typical aluminum conductors for use in electrical wirings of movable bodies include those described in Patent Literatures 1 to 4. However, since the electrical wire conductor described in Patent Literature 1 has large contents of Mg and Si, these elements may cause breakage of wire at the time of wire-drawing or the like. The aluminum conductive wire that is specifically described in Patent Literature 2 has not undergone any finish annealing. An aluminum conductive wire having higher flexibility is required for an operation of attaching it to a vehicle body. Patent Literature 3 discloses an aluminum conductive wire which is lightweight and flexible and has excellent bending property. However, due to its high strength, the aluminum conductive wire has difficulty in handleability. Patent Literature 4 relates to a foil material. Sheet materials and foil materials differ from each other in the form of deformation. This working history affects the formation of a texture in the subsequent steps, to alter the manner for the formation of crystal orientation. Therefore, obtaining a target texture in a wire is technically different from obtaining a target texture in a foil.

### CITATION LIST

### Patent Literatures

Patent Literature 1: JP-A-2008-112620 (“JP-A” means unexamined published Japanese patent application)
Patent Literature 2: JP-A-2006-19163
Patent Literature 3: JP-A-2006-253109
Patent Literature 4: JP-B-54-11242 (“JP-B” means an examined publication of Japanese patent application)

### SUMMARY OF INVENTION

### Technical Problem

The present invention is contemplated for providing an aluminum alloy conductor, which is excellent in electrical conductivity and resistance to bending fatigue, and which has an appropriate yield strength with good handleability.

### Solution to Problem

The inventors of the present invention, having conducted various studies, have found that an aluminum alloy conductor can be produced, which forms a texture and which has a yield strength reduced to an appropriate range, while maintaining excellent resistance to bending fatigue and electrical conductivity, by controlling the production conditions, such as those in the heat treatment of the aluminum alloy and working degree before the heat treatment. The present invention is attained based on the finding.

That is, the problems have been solved by the followings:

(1) An aluminum alloy conductor, which has a texture in which an area ratio of grains each having a (100) plane and being positioned in parallel to a cross-section vertical to a wire-drawing direction of a wire is 20% or more, and which has a grain size of 1 to 30 μm on the cross-section vertical to the wire-drawing direction of the wire.
(2) The aluminum alloy conductor according to (1), wherein the area ratio of the grains each having a (100) plane and being positioned in parallel to the cross-section vertical to the wire-drawing direction of the wire is 20% or more, in a region located within ⅔ of a radius from the center of a circle in the cross-section vertical to the wire-drawing direction of the wire, and wherein the area ratio of the grains each having a (100) plane and being positioned in parallel to the cross-section vertical to the wire-drawing direction of the wire is 20% or more, in a region located inward by ⅓ in a radius direction from the periphery of the circle in the cross-section vertical to the wire-drawing direction of the wire.
(3) The aluminum alloy conductor according to (1) or (2), wherein the aluminum alloy conductor has an alloy composition containing Fe: 0.01 to 0.4 mass %, Mg: 0.04 to 0.3 mass %, Si: 0.02 to 0.3 mass %, and Cu: 0.1 to 0.5 mass %, with the balance being Al and inevitable impurities.
(4) The aluminum alloy conductor according to any one of (1) to (3), wherein 0.2% proof stress in a tensile test measured in a longitudinal direction of the conductor is 35 to 80 MPa.
(5) The aluminum alloy conductor according to any one of (1) to (4), which is used as a conductor wire for a battery cable, a harness, or a motor, in a movable body.
(6) The aluminum alloy conductor according to (5), wherein the movable body is an automobile, a train, or an aircraft.
(7) A method of producing an aluminum alloy wire according to (1) to (6), having the steps of: melting; casting; hot- or cold-working to form a roughly-drawn wire; first wire-drawing; intermediate heat-treatment; second wire-drawing; and final heat-treatment,

wherein the intermediate heat-treatment is carried out at a temperature of 230 to 290° C. for 1 to 10 hours, and wherein the second wire-drawing is carried out at a working ratio of 10 to 30%.

(8) The method of producing an aluminum alloy wire according to (7), wherein the final heat-treatment is a continuous electric heat treatment, and the following formulas are satisfied:

0.03≦x≦0.55, and

26x^{-0.6}+377≦y≦23.5x^{-0.6}+423,

wherein an identical value is inserted for x on the left-hand side and the right-hand side, and wherein x represents an annealing time period (seconds), and y represents a wire temperature (° C.).

(9) The method of producing an aluminum alloy wire according to (7), wherein the final heat-treatment is a continuous running heat treatment, and the following formulas are satisfied:

1.5≦x≦5, and

−50x+550≦z≦−36x+650,

wherein an identical value is inserted for x on the left-hand side and the right-hand side, and wherein x represents an annealing time period (seconds), and z represents an annealing furnace temperature (° C.).

### Advantageous Effects of Invention

Since the aluminum alloy conductor of the present invention has an appropriate yield strength which is not excessively high, the aluminum alloy conductor is excellent in handleability when a wire harness is attached to a vehicle. Further, since the aluminum alloy conductor is excellent in electrical conductivity, the aluminum alloy conductor is useful for conductive wires for battery cables, harnesses or motors, which are to be mounted in movable bodies. In particular, the aluminum alloy conductor is excellent in resistance to bending fatigue, and the aluminum alloy conductor can be suitably used in doors, trunks, hoods (or bonnets) and the like, where very high resistance to bending fatigue is required.

Other and further features and advantages of the invention will appear more fully from the following description, appropriately referring to the accompanying drawing.

### BRIEF DESCRIPTION OF DRAWINGS

FIG. 1 is an explanatory view schematically illustrating the region located within ⅔ of the radius from the center of the circle in the cross-section vertical to the wire-drawing direction of a wire, and the region located inward by ⅓ in the radius direction from the periphery of the circle in the cross-section vertical to the wire-drawing direction of the wire.

FIG. 2 is an explanatory view of the test for measuring the number of repeating times at breakage, which was conducted in the Examples.

### MODE FOR CARRYING OUT THE INVENTION

The aluminum alloy conductor of the present invention can be made to have excellent electrical conductivity and resistance to bending fatigue, and appropriate yield strength, by defining its texture as follows.

### (Texture)

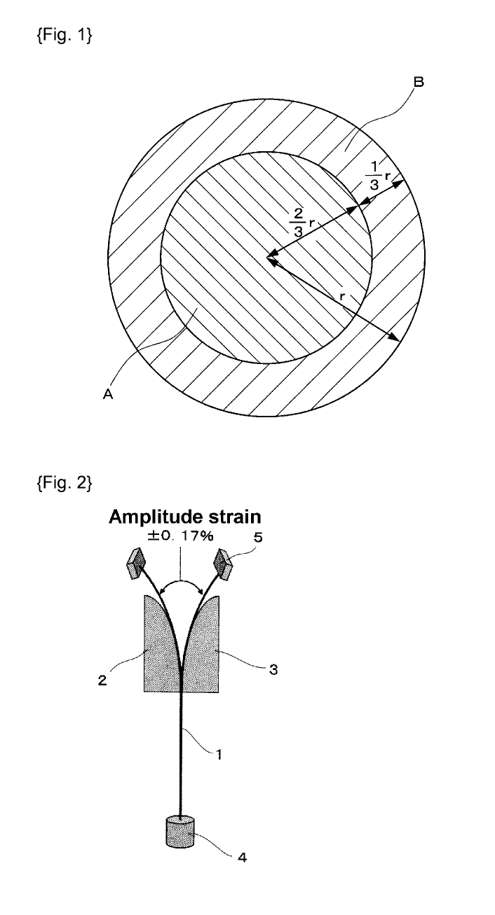

In the present invention, the texture is defined by using a crystal plane that is positioned in parallel to a cross-section vertical to a wire-drawing direction of a wire. The texture means one constituted of polycrystalline grains having many of a certain crystal orientation gathered therein. The texture of the aluminum alloy conductor of the present invention is one in which an area ratio of grains each having a (100) plane and being positioned in parallel to a cross-section vertical to a wire-drawing direction of a wire is 20% or more. More preferably, the texture is one in which the area ratio of the grains, each having a (100) plane and being positioned in parallel to the cross-section vertical to the wire-drawing direction of the wire, is 20% or more (the upper limit is not particularly limited, but is preferably 50% or less), in a region (i.e. central section) that is located within ⅔ of the radius from the center of the circle in the cross-section vertical to the wire-drawing direction of the wire; and the area ratio of the grains, each having a (100) plane and being positioned in parallel to the cross-section vertical to the wire-drawing direction of the wire, is 20% or more (the upper limit is not particularly limited, but is preferably 50% or less), in a region (i.e. outer peripheral section) that is located inward by ⅓ in the radius direction from the periphery of the circle in the cross-section vertical to the wire-drawing direction of the wire. The central section and the outer peripheral section are schematically illustrated in FIG. 1. FIG. 1 is a cross-sectional in a direction vertical to the wire-drawing direction of the wire, in which r represents the radius, the area represented by A is the central section, and the area represented by B is the outer peripheral section. One of the reasons for dividing the entire cross-section of the wire into the two regions is that, in the working of the wire, the manner of deformation is different from each other in the central section and the outer peripheral section of the wire; but in the central section and the outer peripheral section of the wire, each of which has undergone deformation differently, the area ratio of the grains each having a (100) plane is 20% or more in both sections. By making such a texture, the (100) plane can enhance resistance to bending fatigue of the resultant wire, upon bending the wire in the wire-drawing direction, as shown in FIG. 2.

The area ratio in each crystal orientation in the present invention is a value measured by the EBSD method. The EBSD method is an abbreviation of Electron Back ScatterDiffraction, and refers to a technique to analyze a crystal orientation utilizing refractive electron Kikuchi-line diffraction that is generated when a sample is irradiated with electron beam in a scanning electron microscope (SEM). The area ratio is the ratio, to the whole measured area, of the area of grains that are inclined within the range of ±15° from an ideal crystal plane, such as a (100) plane, to the wire-drawing direction. Although the information obtained in the orientation analysis by EBSD includes orientation information up to a depth of several ten nanometers to which electron beam penetrates into the sample, the information is handled as an area ratio in the present specification, since the depth is sufficiently small to the area measured.

### (Grain Size)

In the present invention, the aluminum wire has a grain size of 1 to 30 in the cross-section vertical to the wire-drawing direction. When the grain size is too small, not only a partially un-recrystallized microstructure remains and the target texture cannot be obtained, but also the elongation is lowered conspicuously. When the grain size is too large and a coarse microstructure is formed, deformation behavior becomes uneven, the elongation is lowered similar to the above case of too small grain size, and further the yield strength is lowered conspicuously. The grain size is preferably from 5 to 30 μm, more preferably from 5 to 20 μm.

The “grain size” in the present invention is an average grain size obtained by conducting a grain size measurement with an intersection method by observing with an optical microscope, and is an average value of 50 to 100 grains.

Obtainment of an aluminum alloy conductor having such the texture and grain size can be attained, by setting the alloy composition as follows, and by controlling the manufacturing conditions, such as those in the heat treatment or the working degree or the degree of working) be ore the heat treatment, as follows. Preferred examples of the production method and the alloy composition are described below, but the examples are only for illustrative purposes to help understanding of the invention, and the wire diameter and the like are not intended to be limited thereto.

### (Production Method)

The aluminum alloy conductor of the present invention can be produced via steps of: [1] melting, [2] casting, [3] hot- or cold-working, [4] first wire-drawing, [5] intermediate heat-treatment, [6] second wire-drawing, and [7] final heat-treatment (finish annealing).

### [1] Melting

The melting is conducted by melting predetermined alloying elements each at a given content that gives the given concentration of each embodiment of the aluminum alloy composition mentioned below.

### [2] Casting, and [3] Hot- or Cold-Working

Then, a molten metal is rolled while the molten metal is continuously cast in a water-cooled casting mold, by using a Properzi-type continuous cast-rolling machine which has a casting ring and a belt in combination, to give a rod of about 10 mm in diameter. The cooling speed in casting at that time is 1 to 20° C./sec. Casting and hot-rolling may be carried out by billet casting, extrusion, die-molding, and the like.

### [4] First Wire-Drawing

Then, surface scalping of the resultant rod is conducted to adjust the diameter to 9 to 9.5 mm, followed by wire drawing. The working degree is preferably from 1 to 6. Herein, the working degree η is represented by: η=ln(A₀/A₁), in which the cross-sectional area of the wire (or rod) before the wire drawing is represented by A₀, and the cross-sectional area of the wire after the wire drawing is represented by A₁. If the working degree is too small, in the heat treatment in the subsequent step, the recrystallized grains may be coarsened to conspicuously lower the yield strength and elongation, which is a cause of wire breakage. If the working degree is too large, the wire drawing may become difficult, which is problematic in the quality in that, for example, wire breakage occurs in the wire drawing. Although the surface of the wire (or rod) is cleaned up by conducting surface scalping, the surface scalping may be appropriately omitted. When it is expected that the working degree to obtain the final wire diameter will be 6 or more, a softening treatment is appropriately carried out in the mid course of the operation, to prevent wire breakage in wire-drawing.

### [5] Intermediate Heat-Treatment

Then, to obtain a target texture, an intermediate heat-treatment is conducted on the worked wire subjected to the above cold wire-drawing. Herein, the target texture means a state, in which the grains each having a (100) plane and being positioned in parallel to the cross-section vertical to the wire-drawing direction of the wire, are uniformly dispersed. The intermediate heat-treatment temperature is 230° C. to 290° C. If the intermediate heat-treatment temperature is lower than 230° C., un-recrystallized grains remain, and the target texture is not obtained. If the intermediate heat-treatment temperature is higher than 290° C., the target texture is not obtained because the crystal orientation is rotated in recrystallization. The intermediate heat-treatment temperature is preferably 240° C. to 280° C. The intermediate heat-treatment time period is 1 hour to 10 hours. If the intermediate heat-treatment time period is less than 1 hour, un-recrystallized grains remain, and the target recrystallized texture is not obtained. If the intermediate heat-treatment time period is more than 10 hours, the target texture is not obtained because the crystal orientation is rotated in recrystallization depending on the temperature. The intermediate heat-treatment time period is preferably 2 hours to 8 hours.

### [6] Second Wire-Drawing

The thus-annealed roughly-drawn wire is further subjected to wire drawing. At that time, a working ratio is set to be from 10 to 30%. Herein, the working ratio is obtained by dividing the difference between the cross-sectional area before wire-drawing and the cross-sectional area after wire-drawing by the cross-sectional area before the wire-drawing, and multiplying the resultant value by 100. If the working ratio is less than 10%, the applied strain is insufficient, and the target texture is not obtained upon a heat treatment in the subsequent step. If the working ratio is more than 30%, the recrystallization ratio of (100) plane that is positioned in parallel to the cross-section vertical to the wire-drawing direction becomes low, and the target texture is not obtained. The working ratio is preferably set to be from 15 to 25%.

### [7] Final Heat-Treatment (Finish Annealing)

The thus-worked product that has undergone the above cold-wire drawing (i.e. a drawn wire), is subjected to final heat-treatment by continuous heat treatment. The final heat-treatment can be conducted by either of the two methods: continuous electric heat treatment or continuous running heat treatment.

The continuous electric heat treatment is conducted through annealing by the Joule heat generated from the wire in interest itself that is running continuously through two electrode rings, by passing an electrical current through the wire. The continuous electric heat treatment has the steps of: rapid heating; and quenching, and can conduct annealing of the wire, by controlling the temperature of the wire and the time period for the annealing. The cooling is conducted, after the rapid heating, by continuously passing the wire through water or a nitrogen gas atmosphere. In one of or both of the case where the wire temperature in annealing is too low or too high and the case where the annealing time period is too short or too long, the target texture cannot be obtained. Furthermore, in one of or both of the case where the wire temperature in annealing is too low and the case where the annealing time period is too short, the flexibility that is required for attaching the resultant wire to vehicle to mount thereon cannot be obtained; and, on the other hand, in one of or both of the case where the wire temperature in annealing is too high and the case where the annealing time period is too long, the crystal orientation excessively rotates due to excess annealing, resulting in that the target texture cannot be obtained, and further that the resistance to bending fatigue also becomes worse. Thus, the above-mentioned texture can be formed, by conducting the continuous electric heat treatment under the conditions satisfying the following relationships.

Namely, when a wire temperature is represented by y (° C.) and an annealing time period is represented by x (sec), the continuous electric heat treatment is conducted under the conditions that satisfy:

0.03≦x≦0.55, and

26x^{-0.6}+377≦y≦23.5x^{-0.6}+423

(an identical value is inserted for x on the left-hand side and the right-hand side).

The above formulas represent implementation of recrystallization by controlling the temperature and time period. When the temperature is high, the time period may be short, but if the temperature is a relatively low temperature, a heat treatment for a long time period is required. The formulas express, in a mathematical form, the temperature and time period that are appropriate for recrystallization. Furthermore, these formulas also express the range to give the target texture.

To satisfy the conditions of the formulas, the electrical current value and the voltage value are controlled in the actual operation. The controlling may vary depending on the facility environment or the like, and therefore, the numerical values of electrical current and voltage are not determined to the respective one ranges unambiguously.

The wire temperature y (° C.) represents the temperature of the wire immediately before passing through the cooling step, at which the temperature of the wire is the highest. The y (° C.) is generally within the range of 414 to 620 (° C.).

The continuous running heat treatment is a treatment in which the wire is annealed by continuously passing through an annealing furnace maintained at a high temperature. The continuous running heat treatment has the steps of: rapid heating; and quenching, and can conduct annealing of the wire, by controlling the temperature of the annealing furnace and the time period for the annealing. The cooling is conducted, after the rapid heating, by continuously passing the wire through water or a nitrogen gas atmosphere. In one of or both of the case where the annealing furnace temperature is too low or too high and the case where the annealing time period is too short or too long, the target texture cannot be obtained. Furthermore, in one of or both of the case where the annealing furnace temperature is too low and the case where the annealing time period is too short, the flexibility that is required for attaching the resultant wire to vehicle to mount thereon cannot be obtained; and, on the other hand, in one of or both of the case where the annealing furnace temperature is too high and the case where the annealing time period is too long, the crystal orientation excessively rotates due to excess annealing, resulting in that the target texture cannot be obtained, and further that the resistance to bending fatigue also becomes worse. Thus, the above-mentioned texture can be formed, by conducting the continuous running heat treatment under the conditions satisfying the following relationships.

Namely, when an annealing furnace temperature is represented by z (° C.) and an annealing time period is represented by x (sec), the continuous running heat treatment is conducted under the conditions that satisfy:

1.5≦x≦5, and

−50x+550≦z≦−36x+650

(an identical value is inserted for x on the left-hand side and the right-hand side).

These formulas also express the temperature and time period that are appropriate for recrystallization and by which the target texture is obtained similar to the above, and the relationship can be satisfied by controlling the electrical current value and the voltage value depending on the facility environment.

The z (° C.) is generally within the range of 300 to 596 (° C.).

Furthermore, besides the above-mentioned two methods, the finish annealing may be induction heating by which the wire is annealed by continuously passing through a magnetic field.

### (Alloy Composition)

A preferable alloy composition (i.e. a structure of alloying elements) in the present invention is one which contains 0.01 to 0.4 mass % of Fe, 0.04 to 0.3 mass % of Mg, 0.02 to 0.3 mass % of Si and 0.1 to 0.5 mass % of Cu, with the balance being Al and inevitable impurities.

The reason why the content of Fe is set to 0.01 to 0.4 mass % is to utilize various effects by mainly Al—Fe-based intermetallic compounds. Fe is made into a solid solution in aluminum in an amount of only 0.05 mass % at 655° C., and is made into a solid solution lesser at room temperature. The remainder of Fe is crystallized or precipitated as intermetallic compounds, such as Al—Fe, Al—Fe—Si, Al—Fe—Si—Mg, and Al—Fe—Cu—Si. The crystallized or precipitated product acts as a refiner for grains to make the grain size fine, and enhances resistance to bending fatigue. When the content of Fe is too small, these effects are insufficient, and when the content is too large, the aluminum conductor is poor in the wire-drawing property due to coarsening of the crystallized or precipitated product, which results in that the target resistance to bending fatigue cannot be obtained. Furthermore, the conductor is in a supersaturated solid solution state and the electrical conductivity is also lowered. The content of Fe is preferably 0.15 to 0.3 mass %, more preferably 0.18 to 0.25 mass %.

The reason why the content of Mg is set to 0.04 to 0.3 mass % is to make Mg into a solid solution in the aluminum matrix. Further, another reason is to make a part of Mg form a precipitate with Si, to make it possible to improve resistance to bending fatigue and heat resistance. When the content of Mg is too small, these effects are insufficient, and when the content is too large, the electrical conductivity is lowered. Furthermore, when the content of Mg is too large, the yield strength becomes excessive, the formability and twistability are deteriorated, and the workability becomes worse. The content of Mg is preferably 0.08 to 0.3 mass %, more preferably 0.10 to 0.28 mass %.

The reason why the content of Si is set to 0.02 to 0.3 mass % is to make Si form a compound with Mg, to act to improve resistance to bending fatigue and heat resistance, as mentioned above. When the content of Si is too small, these effects are insufficient, and when the content is too large, the electrical conductivity is lowered. The content of Si is preferably 0.04 to 0.25 mass %, more preferably 0.10 to 0.25 mass %.

The reason why the content of Cu is set to 0.1 to 0.5 mass % is to make Cu into a solid solution in the aluminum matrix. Furthermore, Cu also contributes to the improvement in resistance to bending fatigue, creep resistance, and heat resistance. When the content of Cu is too small, these effects are insufficient, and when the content is too large, corrosion resistance becomes worse and electrical conductivity is lowered. The content of Cu is preferably 0.20 to 0.45 mass %, more preferably 0.25 to 0.40 mass %.

Inevitable impurities in the alloy composition are usual ones, and examples thereof include Ni, Ti, Ga, B, Zn, Cr, Mn, and Zr.

The aluminum alloy conductor of the present invention in a wire form preferably has a diameter 0.15 to 1.2 mm, more preferably a diameter 0.30 to 0.55 mm.

### (Yield Strength (0.2% Proof Stress))

It is preferable that the aluminum alloy wire of the present invention satisfies 0.2% proof stress of 35 to 80 MPa in a tensile test measured in the longitudinal direction of the conductor. If the 0.2% proof stress is less than 35 MPa, the yield strength is so low that the wire cannot withstand any unexpected impact or the like at the time of harness installation or attachment, which may cause wire breakage. If the 0.2% proof stress is more than 80 MPa, there is a problem with handleability. More preferably, the 0.2% proof stress is within 35 to 70 MPa, further preferably 35 to 60 MPa. The 0.2% proof stress is a yield strength against 0.2% permanent elongation calculated by an offset method.

As described above, since the aluminum alloy conductor of the present invention has appropriate yield strength, excellent electrical conductivity, and excellent flexibility, the aluminum alloy conductor is excellent in handleability in operation, and is suitable for electrical wiring of various movable bodies as above, which involves wiring in a limited space. Furthermore, since the aluminum alloy conductor has excellent resistance to bending fatigue, the conductor can be suitably used in repeatable opening and closing units, such as doors.

### EXAMPLES

The present invention will be described in more detail based on examples given below, but the invention is not meant to be limited by these.

### Examples 1 and 2, Comparative Example 1, and Conventional Example 1

Fe, Mg, Si, Cu, and Al in amounts (mass %), as shown in Table 1, were made into the respective molten metals, followed by rolling, while continuously casting in a water-cooled casting mold, by using a Properzi-type continuous cast-rolling machine, to give respective rods with diameter about 10 mmφ. At that time, the cooling speed in casting was 1 to 20° C./sec.

Then, scaling of the rod surface was carried out, to about 9.5 mmφ, followed by subjecting to wire-drawing to 2.6 mmφ, and a softening treatment at a temperature of 350 to 400° C. for 2 to 3 hours. The wire-drawing history and heat treatment to this stage are as follows.

9.5 mmφ→2.6 mmφ→Softening treatment

Further wire-drawing was carried out, followed by an intermediate heat-treatment under the conditions of 220 to 310° C. for 0.5 to 12 hours, and then wire-drawing at a working ratio of 10 to 30% (ones subjected to the wire-drawing at a working ratio of about 9% or about 31% are Comparative examples). The wire-drawing history and heat treatment to this stage are as follows.

→0.330 mmφ→Intermediate heat-treatment→0.315 mmφ (working ratio about 9%)
→0.340 mmφ→Intermediate heat-treatment→0.315 mmφ (working ratio about 14%)
→0.350 mmφ→Intermediate heat-treatment→0.315 mmφ (working ratio about 19%)
→0.360 mmφ→Intermediate heat-treatment→0.315 mmφ (working ratio about 23%)
→0.370 mmφ→Intermediate heat-treatment→0.315 mmφ (working ratio about 28%)
→0.380 mmφ→Intermediate heat-treatment→0.315 mmφ (working ratio about 31%)
→0.370 mmφ→Intermediate heat-treatment→0.340 mmφ (working ratio about 16%)
→0.375 mmφ→Intermediate heat-treatment→0.340 mmφ (working ratio about 20%)
→0.410 mmφ→Intermediate heat-treatment→0.370 mmφ (working ratio about 19%)

The tolerance of the wire diameter was set within ±0.003 mm.

Finally, as shown in Table 1, as the finish annealing, a continuous electric heat treatment was conducted under conditions at a temperature of 426 to 605° C. for a time period of 0.03 to 0.54 seconds, or alternatively a continuous running heat treatment was conducted under conditions at a temperature of 328 to 559° C. for a time period of 1.5 to 5.0 seconds. The temperature measured was the wire temperature y (° C.) measured at immediately before passage into water (in the case of the continuous electric heat treatment) or the annealing furnace temperature z (° C.) (in the case of the continuous running heat treatment), at which the temperature of the wire would be the highest, with a fiber-type radiation thermometer (manufactured by Japan Sensor Corporation). In Conventional example 1, a batch-type heat treatment was conducted under conditions of a heat treatment furnace temperature of 400° C. and a time period of 3,600 seconds.

With respect to the wires prepared in Examples, Comparative examples, and Conventional example, the properties were measured according to the methods described below. The results are shown in Table 2.

### (a) Grain Size (GS)

The transverse cross-section of a sample that was vertically cut out in the wire-drawing direction was embedded with a resin, followed by mechanical polishing, and electrolytic polishing. The conditions of the electrolytic polishing were as follows: polish liquid, a 20% ethanol solution of perchloric acid; liquid temperature, 0 to 5° C.; voltage, 10 V; electrical current, 10 mA; and time period, 30 to 60 seconds. Then, to obtain a contrast of grains, the resultant sample was subjected to anodizing finishing, with 2% hydrofluoroboric acid, under conditions of voltage 20 V, electrical current 20 mA, and time period 2 to 3 min. The resultant microstructure was photographed by an optical microscope with a magnification of 200× to 400×, and the grain size was measured by an intersection method. Specifically, straight lines were arbitrarily drawn in the photographed picture, and the number of intersections of the straight lines and grain boundaries was measured, to obtain the average grain size. The grain size was evaluated by changing the length and the number of straight lines so that 50 to 100 grains would be counted.

### (b) Area Ratios in the Crystal Orientation

In the analysis of crystal orientation in the present invention, use was made of the EBSD method. In the cross-section vertical to the wire-drawing direction of the wire, sample areas primarily with diameter 300 μm were scanned at a step of 0.5 μm, to analyze the orientation. The measurement area and scan step were adjusted for each sample, and the range of the measurement area was set to include 25 or more grains, while the scan step was set to about 1/10 or less of the average grain size of the sample. When the grain was so large that 25 or more grains could not be counted in one analytic image, the analysis was carried out with a sum of 25 or more grains in plural images. The area ratio of the crystal orientation is the ratio of the area of grains inclined within the range of ±15° from an ideal crystal plane, such as (100) plane, positioned in parallel to the cross-section vertical to the wire-drawing direction, to the entire measurement area. In Table 2, the measurement ranges of the (100) area ratio to the entire area, the central section, and the outer peripheral section were respectively set, and the measurement range of the (100) area ratio to the entire area was set such that the measurement area was taken equally to be about 50% of each region from the central section and the outer peripheral section, not to polarize to the either one.

### (c) Yield Strength (YS, 0.2% Proof Stress) and Flexibility (Tensile Elongation at Breakage)

Three test pieces for each sample were tested according to JIS Z 2241, and the average value was obtained, respectively. The yield strength was calculated by an offset method, to use the value (referred to as 0.2% proof stress) against 0.2% permanent elongation. For flexibility, a tensile elongation at breakage of 10% or more was judged as passing the criterion.

### (d) Electrical Conductivity (EC)

Specific resistivity of three test pieces with length 300 mm for each sample was measured, by using a four-terminal method, in a thermostatic bath kept at 20° C. (±0.5° C.), to calculate the average electrical conductivity. The distance between the terminals was set to 200 mm. An electrical conductivity of 57% IACS or more was judged as passing the criterion.

### (e) The Number of Repeating Times at Breakage

As a criterion for the resistance to bending fatigue, a strain amplitude at an ordinary temperature was set to ±0.17%. The resistance to bending fatigue varies depending on the strain amplitude. When the strain amplitude is large, the resultant fatigue life is short, while when small, the resultant fatigue life is long. Since the strain amplitude can be determined, as shown in FIG. 2, by the wire diameter of a wire 1 and the curvature radii of bending jigs 2 and 3, a bending fatigue test can be conducted by arbitrarily setting the wire diameter of the wire 1 and the curvature radii of the bending jigs 2 and 3.

Using a reversed bending fatigue test machine manufactured by Fujii Seiki, Co. Ltd. (currently renamed to Fujii, Co. Ltd.), and using jigs that can impart a bending strain of 0.17% to the wire, the number of repeating times at breakage was measured, by conducting repeated bending. The number of repeating times at breakage was measured from 4 test pieces for each sample, and the average value thereof was obtained. As shown in the explanatory view of FIG. 2, the wire 1 was inserted between the bending jigs 2 and 3 that were spaced by mm, and moved in a reciprocate manner along the jigs 2 and 3. One end of the wire was fixed on a holding jig 5 so that bending can be conducted repeatedly, and a weight 4 of about 10 g was hanged from the other end. Since the holding jig 5 moves in the test, the wire 1 fixed thereon also moves, thereby repeating bending can be conducted. The repeating was conducted under the condition of 100 times of reciprocation/minute, and the test machine has a mechanism in which the weight 4 falls to stop counting when the test piece of the wire 1 is broken. The number of repeating times at breakage was counted by taking one reciprocation cycle as one time.

The number of repeating times at breakage of 60,000 times or more was judged as passing the criterion. Further, the number of repeating times at breakage was normalized to the 0.2% proof stress. When the value obtained by dividing the number of repeating times at breakage by the 0.2% proof stress was 1.5×10³/MPa or more, the resultant sample was judged as passing the criterion.

TABLE 1

| | | | | | | | | | | | | [7] Final | |
|---|---|---|---|---|---|---|---|---|---|---|---|---|---|
| | | | | | | | [5] Intermediate | | [6] Second | | | heat-treatment | |
| | | | | | | | heat-treatment | | wire-drawing | | | conditions | |
| | | | | | | | | Time | Working | Final | | Temp. | Time |
| | | Composition (mass %) | | | | | Temp. | period | ratio | wire diameter | [7] Final | y or z | period x |
| | No. | Fe | Mg | Si | Cu | Al | ° C. | hr | % | mmψ | heat-treatment | (° C.) | (s) |
| Ex 1 | 1 | 0.01 | 0.08 | 0.08 | 0.10 | Bal. | 230 | 4 | 16 | 0.340 | Continuous | 471 | 3.0 |
| | 2 | 0.04 | 0.15 | 0.12 | 0.22 | | 250 | 6 | 14 | 0.315 | running | 559 | 2.0 |
| | 3 | 0.08 | 0.23 | 0.28 | 0.35 | | 290 | 1 | 14 | 0.315 | Continuous | 484 | 0.11 |
| | 4 | 0.10 | 0.06 | 0.23 | 0.44 | | 270 | 2 | 19 | 0.370 | electric | 495 | 0.11 |
| | 5 | 0.14 | 0.16 | 0.06 | 0.13 | | 270 | 2 | 19 | 0.315 | Continuous | 328 | 5.0 |
| | 6 | 0.18 | 0.28 | 0.15 | 0.28 | | 260 | 4 | 23 | 0.315 | running | 540 | 1.5 |
| | 7 | 0.21 | 0.04 | 0.18 | 0.38 | | 260 | 6 | 19 | 0.315 | Continuous | 593 | 0.03 |
| | 8 | 0.25 | 0.12 | 0.25 | 0.50 | | 270 | 2 | 14 | 0.315 | electric | 490 | 0.11 |
| | 9 | 0.28 | 0.30 | 0.10 | 0.18 | | 240 | 10 | 16 | 0.340 | | 482 | 0.18 |
| | 10 | 0.30 | 0.10 | 0.02 | 0.25 | | 250 | 6 | 28 | 0.315 | | 605 | 0.03 |
| | 11 | 0.34 | 0.18 | 0.15 | 0.31 | | 280 | 6 | 20 | 0.340 | | 426 | 0.54 |
| | 12 | 0.40 | 0.25 | 0.30 | 0.42 | | 260 | 4 | 23 | 0.315 | | 490 | 0.11 |
| | 13 | 0.20 | 0.15 | 0.10 | 0.20 | | 260 | 2 | 19 | 0.315 | Continuous | 502 | 0.11 |
| | 14 | 0.20 | 0.15 | 0.10 | 0.20 | | 260 | 5 | 23 | 0.315 | electric | 505 | 0.11 |
| | 15 | 0.20 | 0.15 | 0.10 | 0.20 | | 260 | 5 | 23 | 0.315 | | 480 | 0.18 |
| Ex 2 | 1 | 0.60 | 0.20 | 0.20 | 0.20 | Bal. | 260 | 4 | 14 | 0.315 | Continuous | 495 | 0.11 |
| | 2 | 0.20 | 0.02 | 0.21 | 0.20 | | 260 | 4 | 14 | 0.315 | electric | 496 | 0.11 |
| | 3 | 0.21 | 0.40 | 0.20 | 0.21 | | 270 | 4 | 14 | 0.315 | | 465 | 0.18 |
| | 4 | 0.20 | 0.11 | 0.20 | 0.60 | | 260 | 4 | 14 | 0.315 | | 468 | 0.18 |
| Comp | 1 | 0.20 | 0.10 | 0.01 | 0.08 | Bal. | 270 | 2 | 14 | 0.315 | Continuous | 492 | 0.11 |
| ex 1 | 2 | 0.60 | 0.10 | 0.40 | 0.20 | | 270 | 4 | 14 | 0.315 | electric | 493 | 0.11 |
| | 3 | 0.21 | 0.40 | 0.10 | 0.60 | | 260 | 6 | 14 | 0.315 | | 491 | 0.11 |
| | 4 | 0.20 | 0.20 | 0.10 | 0.20 | | 220 | 4 | 19 | 0.315 | | 492 | 0.11 |
| | 5 | 0.21 | 0.20 | 0.11 | 0.20 | | 310 | 2 | 19 | 0.315 | | 493 | 0.11 |
| | 6 | 0.20 | 0.10 | 0.11 | 0.19 | | 270 | 0.5 | 19 | 0.315 | | 493 | 0.11 |
| | 7 | 0.20 | 0.20 | 0.20 | 0.19 | | 290 | 12 | 19 | 0.315 | | 495 | 0.11 |
| | 8 | 0.20 | 0.20 | 0.20 | 0.20 | | 260 | 6 | 9 | 0.315 | | 493 | 0.11 |
| | 9 | 0.21 | 0.20 | 0.21 | 0.21 | | 260 | 4 | 31 | 0.315 | | 492 | 0.11 |
| | 10 | 0.20 | 0.20 | 0.21 | 0.20 | | 260 | 4 | 19 | 0.315 | | 452 | 0.11 |
| | 11 | 0.20 | 0.20 | 0.21 | 0.20 | | 260 | 2 | 19 | 0.315 | | 528 | 0.11 |
| Conv | 1 | 0.21 | 0.20 | 0.10 | 0.20 | Bal. | — | — | — | 0.315 | Batch-type | 400 | 3,600 |
| ex 1 | | | | | | | | | | | | | |

Note
“Ex” means Example.
“Continuous running” means continuous running heat treatment, and
“Continuous electric” means continuous electric heat treatment.
Note
“Comp ex” means Comparative example, and
“Con ex” means Conventional example.
“Batch-type” means batch-type heat treatment.

TABLE 2

| | | (100) area ratio | | | | | | | The number of | |
|---|---|---|---|---|---|---|---|---|---|---|
| | | | | Outer | | | | Tensile | repeating times at breakage | |
| | | Entire | Central | peripheral | | | | elongation | | The number of |
| | | area | section | section | GS | YS | EC | at breakage | | times/YS |
| | No. | (%) | (%) | (%) | (μm) | (MPa) | (% IACS) | (%) | (×10³) | (10³/MPa) |
| Ex 1 | 1 | 26 | 27 | 26 | 26.2 | 38 | 62.2 | 33.5 | 72 | 1.89 |
| | 2 | 26 | 24 | 28 | 23.1 | 43 | 60.3 | 20.4 | 76 | 1.77 |
| | 3 | 28 | 26 | 29 | 18.8 | 50 | 57.6 | 16.6 | 81 | 1.61 |
| | 4 | 26 | 25 | 27 | 18.3 | 46 | 58.4 | 17.7 | 85 | 1.85 |
| | 5 | 30 | 31 | 29 | 12.1 | 42 | 61.6 | 25.6 | 81 | 1.93 |
| | 6 | 29 | 31 | 28 | 11.9 | 50 | 58.5 | 18.1 | 90 | 1.82 |
| | 7 | 27 | 28 | 27 | 10.2 | 46 | 59.5 | 19.7 | 91 | 2.00 |
| | 8 | 30 | 30 | 30 | 8.2 | 53 | 57.5 | 16.5 | 107 | 2.04 |
| | 9 | 22 | 24 | 23 | 8.1 | 48 | 59.5 | 18.2 | 101 | 2.09 |
| | 10 | 26 | 27 | 25 | 7.6 | 47 | 61.9 | 24.0 | 100 | 2.11 |
| | 11 | 23 | 24 | 22 | 68 | 51 | 59.1 | 18.6 | 105 | 2.06 |
| | 12 | 24 | 22 | 25 | 57 | 54 | 57.5 | 15.3 | 112 | 2.07 |
| | 13 | 37 | 35 | 38 | 18.0 | 42 | 60.3 | 21.5 | 78 | 1.85 |
| | 14 | 46 | 49 | 43 | 19.6 | 40 | 60.3 | 21.2 | 77 | 1.93 |
| | 15 | 51 | 53 | 48 | 20.1 | 37 | 60.3 | 21.8 | 73 | 1.98 |
| Ex 2 | 1 | 22 | 30 | 11 | 5.2 | 54 | 59.0 | 16.7 | 99 | 1.83 |
| | 2 | 21 | 36 | 6 | 10.4 | 45 | 60.5 | 21.3 | 85 | 1.88 |
| | 3 | 22 | 29 | 12 | 9.2 | 50 | 57.6 | 12.3 | 92 | 1.83 |
| | 4 | 20 | 31 | 8 | 10.9 | 49 | 57.6 | 13.8 | 101 | 2.06 |
| Comp | 1 | 10 | 14 | 6 | 14.1 | 39 | 62.4 | 24.0 | 51 | 1.31 |
| ex 1 | 2 | 6 | 8 | 4 | 7.5 | 52 | 54.6 | 14.3 | 62 | 1.20 |
| | 3 | 10 | 12 | 8 | 9.2 | 62 | 55.9 | 13.5 | 68 | 1.11 |
| | 4 | 5 | 4 | 6 | 10.3 | 63 | 60.3 | 20.0 | 88 | 1.40 |
| | 5 | 3 | 3 | 2 | 38.0 | 32 | 60.1 | 7.8 | 48 | 1.52 |
| | 6 | 4 | 6 | 2 | 10.5 | 53 | 61.1 | 23.0 | 77 | 1.47 |
| | 7 | 4 | 6 | 3 | 32.4 | 31 | 59.9 | 8.5 | 48 | 1.55 |
| | 8 | 5 | 6 | 4 | 24.1 | 28 | 59.0 | 6.3 | 42 | 1.50 |
| | 9 | 5 | 7 | 3 | 34.0 | 39 | 58.8 | 16.2 | 55 | 1.43 |
| | 10 | 2 | 3 | 2 | Un-recrystallized | 145 | 58.9 | 2.6 | 121 | 0.83 |
| | 11 | 3 | 5 | 2 | 52.4 | 32 | 58.9 | 7.3 | 30 | 0.94 |
| Conv | 1 | 6 | 10 | 2 | 11.5 | 50 | 58.4 | 18.0 | 70 | 1.40 |
| ex 1 | | | | | | | | | | |

In each of the samples of Example 1, the area ratio of grains each having the (100) plane and being positioned in parallel to the cross-section vertical to the wire-drawing direction of the wire was 20% or more, and the area ratios of the (100) plane in the central section and the outer peripheral section were also 20% or more. In each of the samples of Example 2, the area ratio of grains each having the (100) plane and being positioned in parallel to the cross-section vertical to the wire-drawing direction of the wire was 20% or more, but the area ratio of the (100) plane in any one of the central section and the outer peripheral section was less than 20%. However, in each of the samples of Comparative example 1 and Conventional example 1, the area ratio of grains each having the (100) plane and being positioned in parallel to the cross-section vertical to the wire-drawing direction of the wire was less than 20%.

The samples of Comparative example 1 and Conventional example 1 each were poor in any one of the properties. Contrary to the above, the samples of Example 1 and Example 2 each exhibited satisfactory properties in all of the yield strength, electrical conductivity, tensile elongation at breakage, and the number of repeating times at breakage.

Having described our invention as related to the present embodiments, it is our intention that the invention not be limited by any of the details of the description, unless otherwise specified, but rather be construed broadly within its spirit and scope as set out in the accompanying claims.

This non-provisional application claims priority under 35 U.S.C. §119 (a) on Patent Application No. 2011-080344 filed in Japan on Mar. 31, 2011, which is entirely herein incorporated by reference,

### REFERENCE SIGNS LIST

1 Test piece (wire)
2, 3 Bending jig
4 Weight
5 Holding jig

1. An aluminum alloy conductor, which has an alloy composition, consisting of Fe: 0.01 to 0.4 mass %, Mg: 0.04 to 0.3 mass %, Si: 0.02 to 0.3 mass %, and Cu: 0.1 to 0.5 mass %, with the balance being Al and inevitable impurities,
wherein the aluminum alloy conductor has a texture in which an area ratio of grains each having a (100) plane and being positioned in parallel to a cross-section vertical to a wire-drawing direction of a wire is 20% or more, and
wherein the aluminum alloy conductor has a grain size of 1 to 30 μm on the cross-section vertical to the wire-drawing direction of the wire.

2. The aluminum alloy conductor according to claim 1, wherein 0.2% proof stress in a tensile test measured in a longitudinal direction of the conductor is 35 to 80 MPa.

3. The aluminum alloy conductor according to claim 1,
wherein the area ratio of the grains each having a (100) plane and being positioned in parallel to the cross-section vertical to the wire-drawing direction of the wire is 20% or more, in a region located within ⅔ of a radius from the center of a circle in the cross-section vertical to the wire-drawing direction of the wire, and
wherein the area ratio of the grains each having a (100) plane and being positioned in parallel to the cross-section vertical to the wire-drawing direction of the wire is 20% or more, in a region located inward by ⅓ in a radius direction from the periphery of the circle in the cross-section vertical to the wire-drawing direction of the wire.

4. The aluminum alloy conductor according to claim 3, wherein 0.2% proof stress in a tensile test measured in a longitudinal direction of the conductor is 35 to 80 MPa.

5. A conductor wire for a battery cable, a harness, or a motor, in a movable body, comprising the aluminum alloy conductor according to claim 1.

6. The conductor wire according to claim 5, wherein the movable body is an automobile, a train, or an aircraft.

7. A method of producing an aluminum alloy conductor according to claim 1, having the steps of:
melting;
casting;
hot- or cold-working to form a roughly-draw wire;
first wire-drawing;
intermediate heat-treatment;
second wire-drawing; and
final heat-treatment,
wherein the intermediate heat-treatment is carried out at a temperature of 230 to 290° C. for 1 to 10 hours,
wherein the second wire-drawing is carried out at a working ratio of 10 to 30%, and
wherein the final heat-treatment is either:
[1] a continuous electric heat treatment, and the following formulas are satisfied:
0.03≦x≦0.55, and
26x^{-0.6}+377≦y≦23.5x^{-0.6}+423,
in which an identical value is inserted for x on the left-hand side and the right-hand side, and
in which x represents an annealing time period (seconds), and y represents a wire temperature (° C.); or
[2] a continuous running heat treatment, and the following formulas are satisfied:
1.5≦x≦5, and
−50x+550≦z≦−36x+650,
in which an identical value is inserted for x on the left-hand side and the right-hand side, and
in which x represents an annealing time period (seconds), and z represents an annealing furnace temperature (° C.).
